(19) United States
(12) Patent Application Publication
(10) Pub. No.: US 2011/0148593 A1
(43) Pub. Date: Jun. 23, 2011

(54) METHOD FOR READING A VEHICLE TAG WITHIN A READ STATION

(76) Inventors: Robert Leon Benedict, Tallmadge, OH (US); Joseph Carmine Lettieri, Hudson, OH (US); John Michael Fenkanyn, Akron, OH (US); Mario Vincent Orosa, North Canton, OH (US); Richard Nicholas Crano, Akron, OH (US); Joseph Paul Batcho, SR., Warren, OH (US)

(21) Appl. No.: 12/640,028

(22) Filed: Dec. 17, 2009

(51) Int. Cl. H04Q 5/22

(52) U.S. Cl. 340/10.3

(57) ABSTRACT

A method of reading a data transmission from an electronic transmitting device mounted to a vehicle tire assembly includes: positioning a convex upper surface of a stand to intercept a vehicle tire of the vehicle tire assembly; establishing rotational engagement between the vehicle tire and the convex upper surface of the stand to slow the speed of the vehicle and reduce the rotational rate at which the vehicle tire rotates to a targeted reduced rotational read rate; and directing an antenna field from at least one antenna toward an approach path (and at least one antenna toward the exiting path) of the vehicle tire to the convex upper surface and lower surface of the stand to receive data transmission from the electronic transmitting device as the vehicle tire passes over the stand upper surface then down the lower surface at the reduced rotational read rate.

### FIELD OF THE INVENTION

The invention relates generally to RFID device readers and, more specifically, to a method of reading tire mounted RFID devices within a read station.

### BACKGROUND OF THE INVENTION

Radio frequency identification devices (RFID devices) are useful in association with sundry product categories and have gained widespread commercial importance and acceptance. Such devices generally have memory storage capability for electronically storing product-specific information such as product history and a product identification number. The device further provides an integrated transmitter that transmits responsive to a prompt signal the stored data for receipt by a receiver antenna. For example, it is known to associate an RFID with a vehicle tire or wheel rim assembly in order to access tire, vehicle, and/or wheel related identification and history throughout the lifetime service of the product.

It is important in any RFID transmission system that the data transmitted by the product-based RFID device be transmitted reliably, expeditiously, and without error to a reader for processing and use. Without a reliable data transmission and reception capability, the integrity of the information downloaded and the utility of the system will be compromised. In a vehicle tire or wheel-based application, the construction of a reliable RFID data transmission system presents numerous application-specific challenges that must be addressed in order to achieve an acceptable level of performance.

### SUMMARY OF THE INVENTION

According to an aspect of the invention, a method of reading a data transmission from an electronic transmitting device mounted to a vehicle tire assembly includes: positioning a convex upper surface of a stand to intercept a vehicle tire of the vehicle tire assembly; establishing rotational engagement between the vehicle tire and the convex upper surface of the stand to slow the speed of the vehicle and reduce the rotational rate at which the vehicle tire rotates to a targeted reduced rotational read rate; and directing an antenna field from at least one antenna toward an approach path of the vehicle tire to the convex upper surface of the stand to receive data transmission from the electronic transmitting device as the vehicle tire passes over the stand upper surface at the reduced rotational read rate.

According to another aspect of the invention, the method includes directing a second antenna field from at least a second antenna toward an exit path of the vehicle tire from the upper surface of the stand to receive data transmission from the electronic transmitting device as the vehicle tire passes over the stand upper surface at the reduced rotational read rate.

In yet another aspect, the method includes tilting the directionally aimed first and second antenna fields at an acute tilt angle within a range of 13 to 15 degrees toward the approach and exit paths, respectively, of the vehicle tire relative to the stand upper surface. The first and second antenna fields may, in another aspect, be positioned to place the transmitting device into a continuously coupled relationship with at least one of the first and second antenna fields as the vehicle tire passes across the convex upper surface.

According to a further aspect, the method includes mounting the transmitting device to the vehicle tire assembly to rotate with the tire; and configuring the height and concavity of the upper convex surface to operatively require the tire and the transmitting device to substantially complete at least one revolution at the targeted reduced rotational read rate as the tire passes over the upper convex surface span.

### BRIEF DESCRIPTION OF THE DRAWINGS

The invention will be described by way of example and with reference to the accompanying drawings in which:

FIG. 1A is a schematic representation of an antenna and the field generated therefrom with a transmitting device approaching the antenna;

FIG. 1B is a schematic representation of the antenna of FIG. 1A tilted toward the approaching transmitting device.

FIG. 2 is a top perspective view of an antenna assembly configured pursuant to the invention.

FIG. 3 is an exploded bottom perspective view of the antenna assembly of FIG. 2.

FIG. 4A is a schematic representation of a vehicle tire initial travel over the antenna assembly.

FIG. 4B is a schematic representation of a the vehicle tire traveling over a rearward surface portion of the antenna assembly.

FIG. 5 is a schematic representation of a read station in which four antenna assemblies are positioned to intercept four vehicle tires and transmit downloaded data from the transmitting devices in the tires to a remote data processing computer.

FIG. 6 is a top perspective view of a center unit of an alternative embodiment of an antenna assembly configured pursuant to the invention.

FIG. 7 is a partially exploded bottom perspective view of the center unit.

FIG. 8 is a bottom partially exploded view of the three unit alternative antenna assembly embodiment.

FIG. 9 is a schematic representation of a read station in which four three-component antenna assemblies are positioned to intercept truck tires and transmit downloaded data from the transmitting devices in the tires to a remote data processing computer.

### DETAILED DESCRIPTION OF THE INVENTION

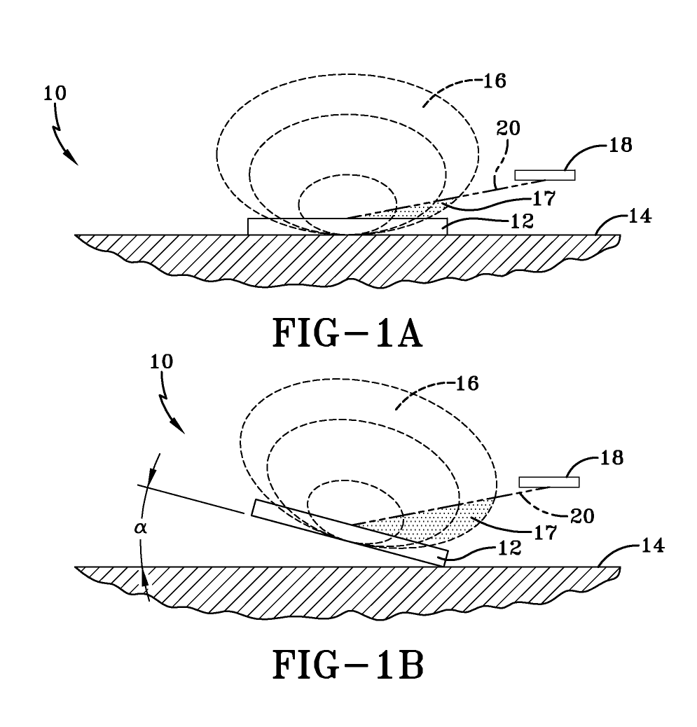

Referring to FIGS. 1A and 1B, a schematic of an antenna system 10 is shown including an antenna 12 positioned flat on a ground surface 14. The antenna 12 generates a field or beam pattern 16 for the purpose of receiving data transmission signals 20 from an approaching electronic device 18. Device 18 is of a type commercially available and used, such as a radio frequency identification (RFID) tag. The tag 18 may be mounted to a product that moves toward and away from a read station in which the antenna 12 and its generated beam pattern 16 is situated. The speed at which the tag 18 approaches and leaves the vicinity of the antenna 12 will affect the time interval in which the transmitted data 20 is received by the antenna field 16. The read range of the antenna 12 is increased and represented by the shaded region 17 of the field 16. A maximized read range will positively affect the coupling efficiency between the transmitted signal 20 and the antenna field 16 and serve to promote a complete and accurate data transmission as the tag approaches and leaves the vicinity of the antenna 12.

FIG. 1B shows an alternative antenna position within a read station in which the antenna 12 is tilted toward the approach path of the tag 18. Tilting of the antenna 12 at an acute angle α with respect to the ground surface 14 will cause the beam pattern 16 to tilt at angle α toward the approach path (represented by data transmission 20) of the tag 18. The tilting of the field 16 toward the approach path of the tag 18 serves to enlarge the read field 17 as shown by the larger shaded region of FIG. 1B as compared with the shaded region of FIG. 1A. The read range of the antenna 12 is thus maximized by introducing a mechanical tilt at angle α. The enlargement of the read range 17 effected by mechanically tilting the antenna 12 improves the reliability of the system and ensures that transmitted data will be captured as the tag 18 moves through the read zone. With the mechanical tilt, more of the cross-sectional area of the antenna pattern 16 is available and improved transmission efficiency is gained.

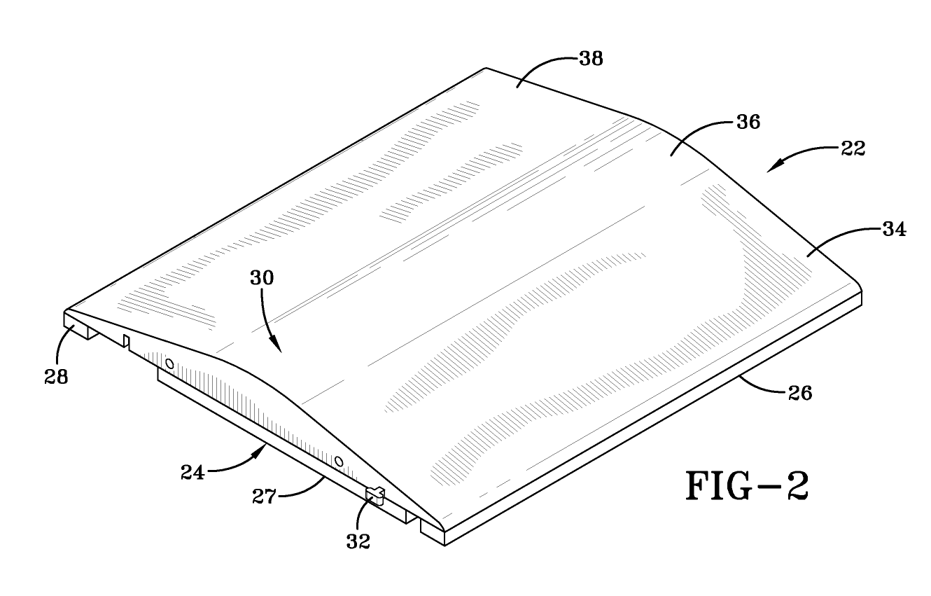

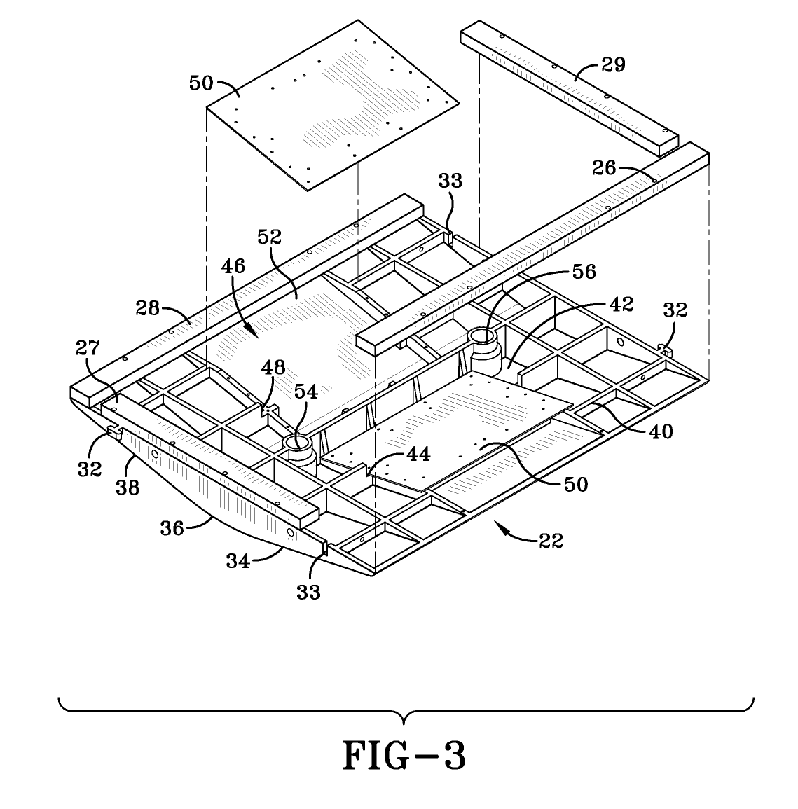

With reference to FIGS. 2 and 3, a tilted antenna system stand 22 is shown to include a stand freestanding base 24 supported by elongate support legs 26, 27, 28, and 29. The support legs affix to an underside of the base 24 along outer peripheral locations and for support of the base on a ground surface. The stand 22 is provided with a cover 30 having a convex profile that covers the top of the base 24. As used herein, “convex” is meant in a general sense. The cover upper convex surface may be composed of adjoining flat surface segments or be continuously radiussed as shown. The base is formed of any suitably strong material such as plastic, and is configured having a protruding latch finger 32 and latch slot 33 spaced apart along each side of the stand. The finger 32 is shaped to interlock with the slot 33 of a like-configured unit to thereby chain multiple stands together in a series. The stand cover 30 is of convex sectional configuration, formed to include a forward inclined surface 34 extending to an apex or crown 36, and a rearward inclined surface 38 extending from the crown 36 to a rearward side of the stand. A matrix of cross-ribs 40 may be molded into the underside of the base 24 for adding strength to the structure.

The cross-ribs 40 define a forward antenna receiving recess 42 with support notches 44 formed in ribs along the sides of the recess 42. A similarly configured rearward antenna receiving recess 46 is positioned between the cross-ribs 40 of the rearward portion of the base, likewise providing support notches 48 formed in ribs along the sides of the rearward recess 46. A forward antenna 50 is sized to fit within the forward recess 42, resting upon notches 44. A rearward antenna 52 is positioned within rearward recess 46 and rests upon the notches 48. The notches 44, 48 formed within the cross-ribs 40 form an angled seat within the recesses 42, 46 such that the antennae 50, 52 when positioned within the recesses are at an acute angle with respect to a vertical centerline of the stand 22. The antennae 50, 52 angle in opposite directions from the centerline at an acute angle α (see FIG. 1B) which is preferably between 13 to 15 degrees, although angles of different magnitudes may be used respectively for the two antenna in order to create the antenna field desired.

It will be appreciated that the cover 30 is formed of RF transparent material and serves to enclose the antennae 50, 52 in their angled position within the stand. Assembly posts 54, 56 mate within sockets formed in the cover to attach the cover to the base 24. The antennae 50, 52 are angled within the ground surface 14 in FIGS. 1A and 1B at the aforementioned acute angle which may be the same for each antenna or different, depending on the system objectives and requirements. In the assembled condition, the antennae 50, 52 generally reside beneath the inclined RF transparent surfaces 34, 38, respectively. The angle of inclination of the antennae 50, 52 and the surface portions 34, 38 may be the same or differ. The stand assembly 22, it will be appreciated, produces a speed bump when the stand is positioned to intercept the wheels of an oncoming vehicle. The tires of the vehicle are intended to ride up the forward surface 34, over the crest or apex 36, and down the rearward inclined surface 38. The slopes of inclined surface 34, 38 are designed to create a bump of desired severity so that a vehicle traveling over the stand 22 will be slowed to an objective read speed. Thus, the slope of the inclined surfaces 34, 38 may be more or less than the slope of the inclined antennae 50, 52 within the stand, depending on the degree of bump necessary to slow the oncoming vehicle to an objective read speed.

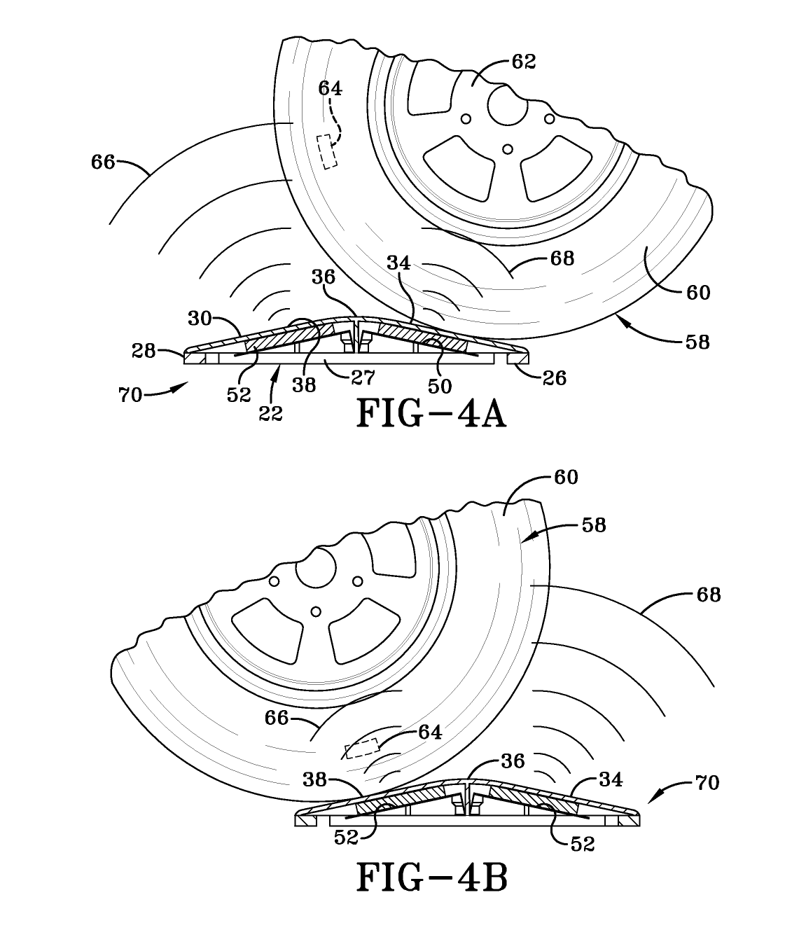

FIGS. 4A and 4B illustrate the operation of the speed bump created by the stand 22 and the tilted antenna 50, 52 positioned within the stand as a vehicle tire 58 rides up, over, and down the stand surfaces 34, 36, 38. The tire 58 includes a sidewall 60 and mounts to a rim 62 in standard fashion. An RFID tag 64 is secured to the tire 58 by conventional means at a conventional location such as to the tire inner liner (not shown) defining the tire cavity. So positioned, the tag 64 rotates with the tire 58 at the same speed of rotation. An antenna beam pattern 68 from the forward antenna 50 is tilted toward the tire 58 approach path as the tire engages and rolls up the inclined surface 34 of the stand 22. The tilt of the antenna 50 within the stand 22 tilts the field 68 so as to allow the signal from the tag 64 access to more of the field cross-section as tag 64 rotates with the tire. The second, rearwardly mounted antenna 52 is likewise tilted within the stand in the opposite (rearward facing) direction from the forward (forward facing) tilted antenna 50. The field or beam pattern 66 is thus tilted to the rear by the generally same angle α as the forward beam pattern 68 from antenna 50 tilts forward. It is preferred, although not necessary, that the acute tilt angle α be within the range of 13 to 15 degrees.

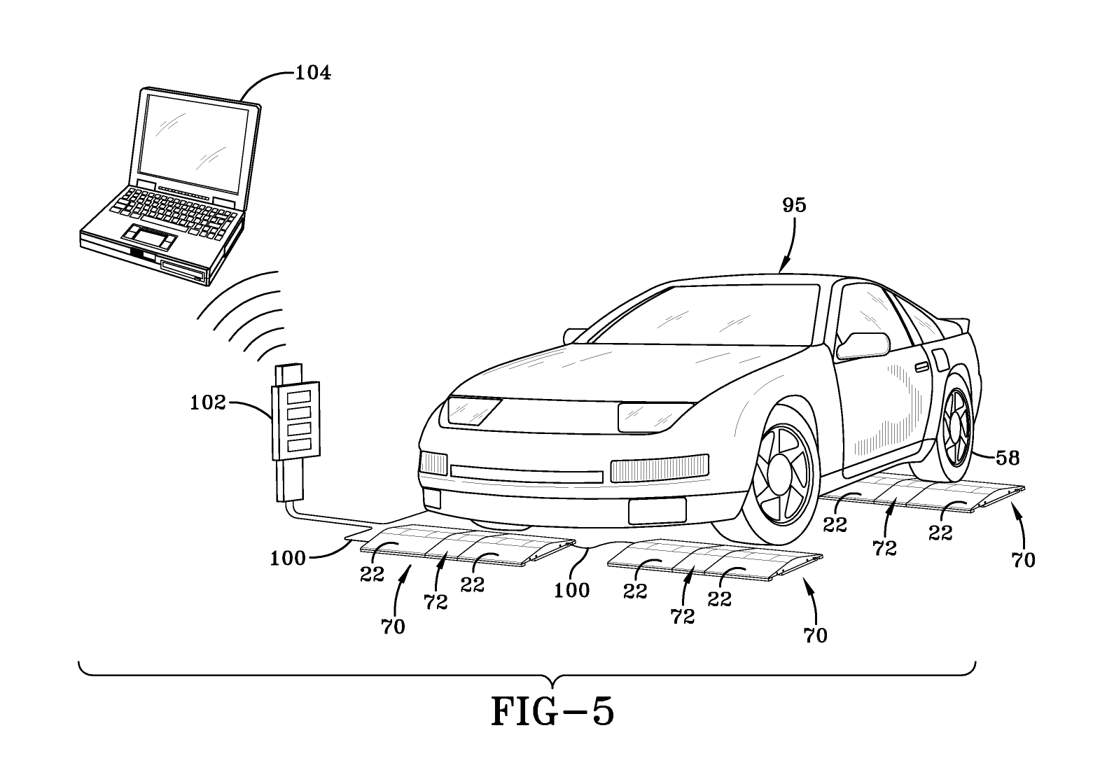

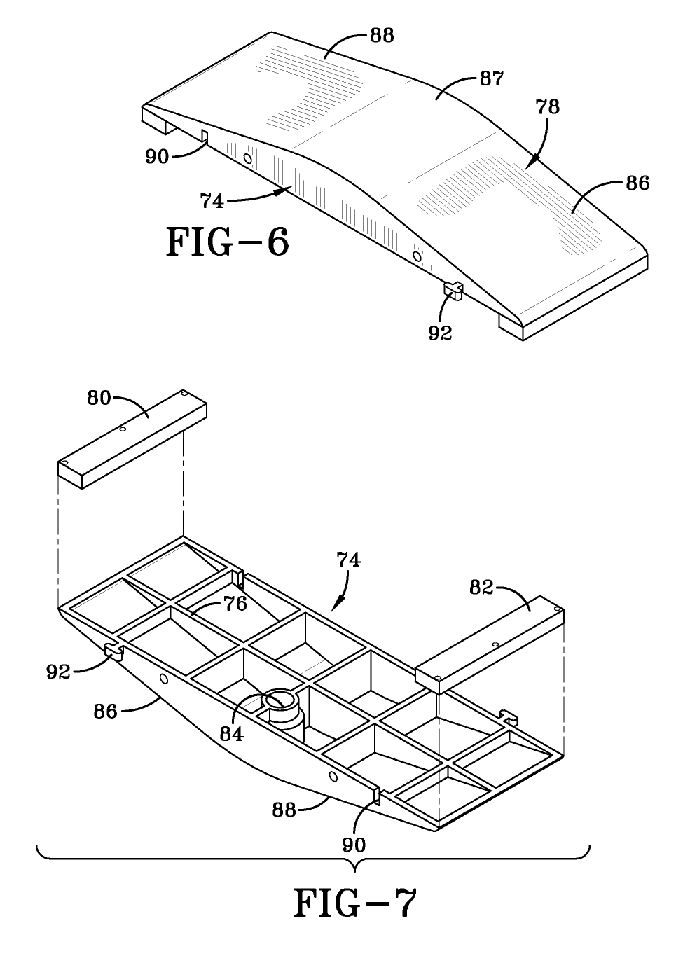

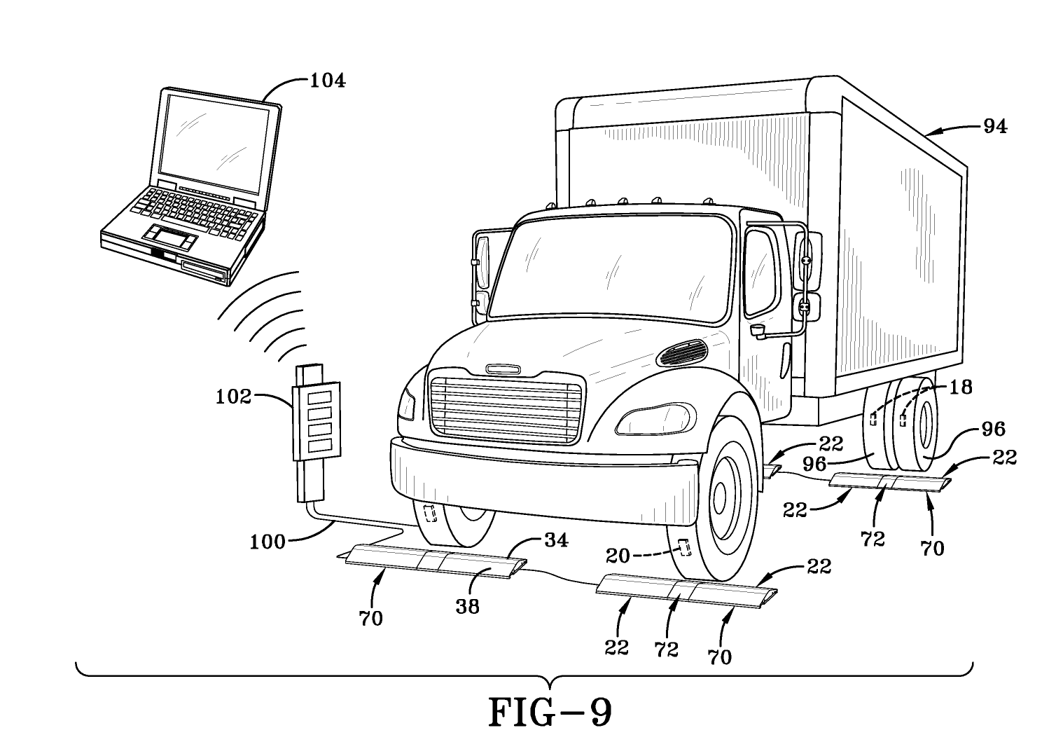

The position of the antenna 50 relative to the antenna 52 is close enough such that the beam patterns 66, 68 overlap to a minimal extent and cover without a gap the area above the stand 22. Thus, the tag 64, mounted to the tire 58, will rotate over the surfaces 34, 36, 38 with the tire and complete a revolution with the tire 58 within the time interval required for the tire to move over a stand and/or multiple antenna component assemblies 70 as shown in FIGS. 5 and 9. As the tag rotates, data transmission by the tag will intersect the beam patterns 66, 68 of one or both of the antenna 50, 52. A reliable and complete transmission of data is thereby assured.

Moreover, the speed at which the tag 64 rotates with the tire 58 may be controlled by controlling the front to rear span and/or degree and/or extent of incline of the speed bump represented by surfaces 34, 36, and 38 of the stand 22. A higher angle of tilt of the forward and rearward surface or lengthening the surfaces 34, 36, and/or 38 raises the “bump” and will generally obligate the driver of the vehicle to slow down to a greater extent. This, in turn, slows the rotational speed of the tire and tag 64 over the stand 22 and elongates the time period (read interval) during which the tag transmission may be communicated to the antenna patterns 66, 68. Conversely, lowering the “bump” by adjusting the angle of tilt and/or width of stand surfaces 34, 36, and 38 will obligate a driver to slow the vehicle to a lesser extent. The read interval between the tag 64 and the beam patterns 66, 68 will be reduced accordingly. By adjusting the size (span) and/or tilt of the stand surfaces with the tilt of the antenna beam patterns, an optimal read interval may be attained that is long enough to effect a highly reliable data transmission without slowing the vehicle unnecessarily.

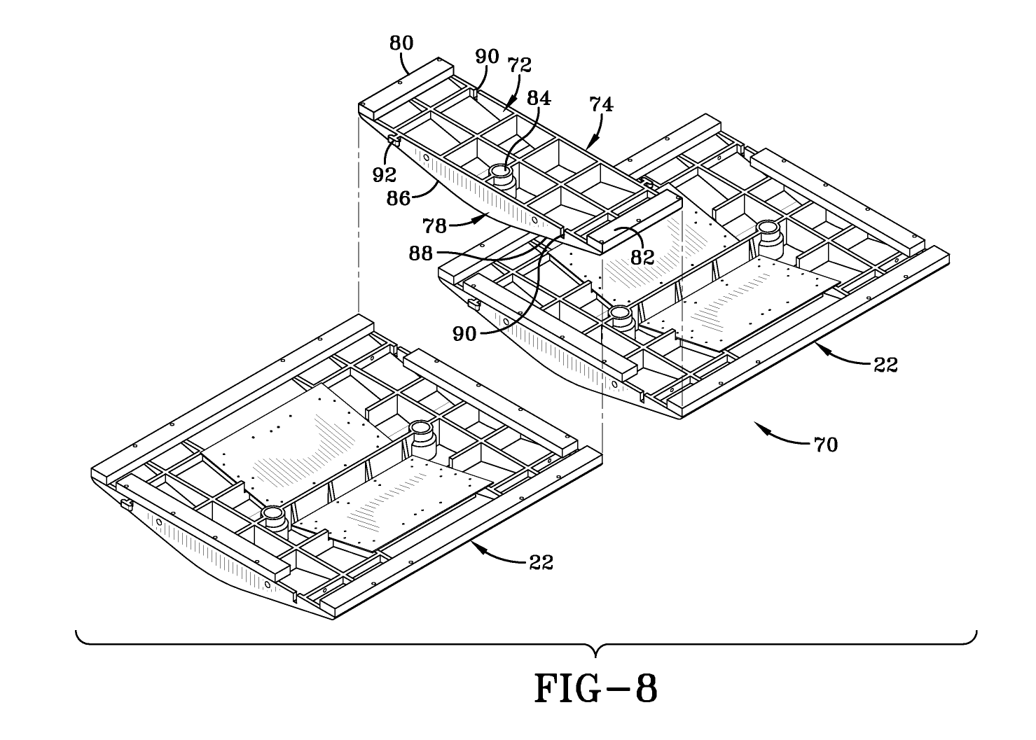

The tag 64 may be mounted to the inner liner of the sidewall of the tire 58 as explained. For such a mounting location, it may be beneficial to mount the antenna 50, 52 to a side of the tire 58 for improved coupling between the antenna beam pattern and the data transmission from the tag. To facilitate mounting the antenna to a side of a tire traveling over the stand, a bridging unit 72 may be utilized in a three-component stand assembly 70 such as that shown in FIGS. 6, 7, and 8. The tire is intended to ride directly over the bridging unit upper convex surface. The bridging unit 72 is situated between two antenna assemblies of the type described previously. The center or bridging unit 72 includes a body 74 having cross-rib reinforcement 76 and a convex upper surface 78. A pair of elongate support legs 80, 82 affix to an underside of the body 74 and support the body on a ground surface. A socket 84 connects the body 74 to the ground surface 14 in FIGS. 1A and 1B. The cover provides the arched or convex outer surface 78 and includes a forward inclined surface 86 and a rearward inclined surface 88, separated by an apex region 87. The forward and rearward surfaces 86, 88 have an acute tilt angle generally the same as the forward and rearward surfaces of the cover 30 (FIGS. 2 and 3) described previously. The bridging unit body 74 is formed to provide a latch finger 92 and a latch slot 90 along each longitudinal side that mate and interconnect with the latch 32 and latch slot 33 of the base 24. Accordingly, a three component series may be interconnected consisting of two antenna stands 22 on opposite side of a single bridging stand unit 72 as shown in FIG. 8. The center or bridging unit surfaces 86, 88 are targeted by a vehicle operator and tire 58 rides up and over the center unit during a drive-through read operation.

The incline of the surfaces 86, 88 complement the incline of surfaces 34, 38 of the antenna assembly 22. In the three component version of the invention, the two antenna assemblies 22 on opposite sides of the center unit 72 are to the side of the tire 58 and function to ensure that a complete and accurate data transmission between the tag 64 and the antenna 50, 52 will occur. The tilt of the antenna 50, 52 within each of the antenna assemblies 22 on opposite sides of the center unit 72 is generally the same, and it is preferred that the tilt angle be generally 13 to 15 degrees although more or less tilt may be employed if desired.

With reference to FIGS. 4A and 4B, the tag 64 rotates with the tire 58. It is desirable to slow the vehicle by means of the speed bump formed of one or two antenna stand assemblies 22 and, if desired, bridging unit 72. A single antenna stand assembly may be employed if it is preferred that the tire ride directly over the convex surface of RFID transparent cover 30. If an adjacent position of the antenna 50 and/or 52 is desired, stand assembly 22 may be used with a bridging unit 72. The tire rides over the bridging unit 72 in such a configuration with the antenna members 50, 52 positioned to the side. It is preferable that the speed bump configuration slow the rotational rate of the vehicle tire 58 to a targeted reduced rotational read rate optimal for effecting reliable data transmission as the tire passes over the convex upper surface. The size, shape and height of the bump will be selected to induce the vehicle operator to lower the speed of the vehicle to achieve the targeted reduced rotational read rate speed. The span and degree of incline created by surfaces 34, 36, 38 or, surface 86, 87, and 88 if a bridging unit 72 is employed, is constructed to operatively require the tire and the transmitting device 64 to at least complete one revolution over a stand and/or multiple antenna component assemblies 70 as shown in FIGS. 5 and 9 at the targeted reduced rotational read rate speed as the tire traverses over the bump. The fields 66, 68 are established above the tire path across the path in such a manner so as to continuously maintain the tag within one or the other or both of the fields 66, 68 as the tire rotates at the reduced read rate speed across the bump. In so doing, data transmission between the tag and the antenna fields is continuous and highly reliable and accurate transmission of data is facilitated.

FIGS. 5 and 9 illustrate the deployment of a three-component antenna assembly system into a read station for a passenger car (FIG. 5) station and for a cargo truck drive-through station (FIG. 9). In FIG. 5, four three-component assemblies 70 are positioned to intercept the four tires on a passenger car and form a drive-through read station. The car is driven through the station and the vehicle tires encounter the four stand assemblies generally simultaneously. The driver steers the tires toward and over the center unit 72 of each three-component stand and, upon encountering the four “bumps”, slows the vehicle to an optimal read speed. As the tires travel over the center units 72, respectively, the two antenna assembly units 22 on opposite sides of each center unit engage the tag on each tire and data transmission from the tag to the antenna within each unit 22 is established and completed. At the reduced vehicle speed caused by the speed bumps, the optimal time interval required to effect complete data transmission is achieved. Data downloaded to the antenna may then be conducted by wiring 100 to a transmitting device 102 for wireless data transmission to a processing computer 104.

In FIG. 9, four three-component assemblies 70 are positioned to intercept the tires on a cargo truck and form a drive-through read station. The truck 94 may have a pair of forward tires and dual tandem tires in the rear as shown. The truck 94 is driven through the station and the vehicle tires encounter the four stand assemblies 70 generally simultaneously. The driver steers the tires toward and over the center unit 72 of each three-component stand 70 and, upon encountering the four “bumps”, slows the vehicle to an optimal reduced read speed with each tire rotating at least one revolution at the reduced read speed over a respective bump. As the tires travel over the center units 72, respectively, the two antenna assembly units 22 on opposite sides of each center unit engage the tag of each tire and data transmission from the tag to the antenna within each unit 22 is established and completed. At the reduced vehicle speed caused by the speed bumps, the optimal time interval required to effect complete data transmission is achieved. The tandem tires in the rear of the truck 94 may be read simultaneously as the tires pass over the center bridging unit 72 by the two assemblies 22 positioned to the side of the unit 72. Data downloaded to the antenna may then be conducted by wiring 100 to a transmitting device 102 for wireless data transmission to a processing computer 104.

With reference to FIGS. 4A and 4B and 9, as described previously, the bumps created by the assemblies 70 are configured to slow the vehicle to a lower speed that will allow the tags 64 in FIGS. 4A and 4B and tags 18 and 20 in FIG. 9 to rotate at least one complete revolution as the tire carrying the tag passes over a stand and/or multiple antenna component assemblies 70 as shown in FIGS. 5 and 9 through the fields created by antenna 50, 52. The fields created by antenna 50, 52 are positioned to keep read contact with the tag throughout its revolution over the speed bump to insure a reliable and accurate data transmission. The tilt of the antenna 50 orients its field pattern toward the tire as the tire engages and rides up onto the assembly 70 and the tilt of antenna 52 orients its field pattern toward the tire as the tire travels down a rearward surface portion of the assembly 70 and exits.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method of reading a data transmission from an electronic transmitting device mounted to a vehicle tire assembly, comprising:
positioning a convex upper surface of a stand to intercept a vehicle tire of the vehicle tire assembly;
establishing rotational engagement between the vehicle tire and the convex upper surface of the stand to slow the speed of the vehicle and reduce the rotational rate at which the vehicle tire rotates to a targeted reduced rotational read rate;
directing an antenna field from at least one antenna toward an approach path of the vehicle tire to the convex upper surface of the stand to receive data transmission from the electronic transmitting device as the vehicle tire passes over the stand upper surface at the reduced rotational read rate.

2. The method of claim 1, wherein further comprising tilting the directionally aimed one antenna field at an acute tilt angle toward an approach path of the vehicle tire onto the stand upper surface.

3. The method of claim 2, wherein further comprising establishing the acute tilt angle of the directionally aimed one antenna field substantially within a range of 13-15 degrees to a horizontal ground plane.

4. The method of claim 2, wherein further comprising mounting the convex upper surface and the at least one antenna in a common stand assembly.

5. The method of claim 4, wherein further comprising positioning the one antenna adjacent to the convex upper surface in the common stand assembly.

6. The method of claim 1, wherein further comprising: mounting the transmitting device to the vehicle tire assembly to rotate with the tire; and configuring the height and concavity of the upper convex surface to operatively require the tire and the transmitting device to substantially complete at least one revolution at the targeted reduced rotational read rate as the tire passes over the upper convex surface span.

7. The method of claim 1, wherein further comprising directing a second antenna field from at least a second antenna toward an exit path of the vehicle tire from the upper surface of the stand to receive data transmission from the electronic transmitting device as the vehicle tire passes over the stand upper surface at the reduced rotational read rate.

8. The method of claim 7, wherein further comprising tilting the directionally aimed second antenna field at an acute tilt angle toward the exit path of the vehicle tire from the stand upper surface.

9. The method of claim 8, wherein further comprising establishing the acute tilt angle of the directionally aimed second antenna field substantially within a range of 13-15 degrees to a horizontal ground plane

10. The method of claim 8, further comprising tilting the directionally aimed one antenna field at an acute tilt angle toward an approach path of the vehicle tire onto the stand upper surface.

11. The method of claim 10, wherein further comprising positioning the first antenna field and the second antenna field to place the transmitting device into a continuously coupled relationship with at least one of the first and second antenna fields as the vehicle tire passes across the convex upper surface.

12. The method of claim 11, wherein further comprising: mounting the transmitting device to the vehicle tire assembly to rotate with the tire; and configuring the height and concavity of the upper convex surface to operatively require the tire and the transmitting device to substantially complete at least one revolution at the targeted reduced rotational read rate as the tire passes over the upper convex surface span.
